(19) United States
(12) Patent Application Publication
(10) Pub. No.: US 2008/0141735 A1
(43) Pub. Date: Jun. 19, 2008

(54) Lock for an Ultralow Temperature Refrigerator

(75) Inventors: Chengdang Liu, Shandong (CN); Wentao Bai, Shandong (CN); Zhengsheng Li, Shandong (CN); Haimei Wang, Shandong (CN); Pengzhen Tian, Shandong (CN)

Correspondence Address: HOFFMANN & BARON, LLP, 6900 JERICHO TURNPIKE, SYOSSET, NY, 11791, US

(73) Assignees: HAIER GROUP COMPANY, Shandong (CN); HAIER MEDICAL AND LABORATORY PRODUCTS CO., LTD., Shandong (CN)

(21) Appl. No.: 11/957,530

(22) Filed: Dec. 17, 2007

(30) Foreign Application Priority Data
Dec. 18, 2006 (CN) 200610168325.6

(51) Int. Cl. E05B 65/52

(52) U.S. Cl. 70/77

(57) ABSTRACT

The present invention discloses a lock for an ultralow temperature refrigerator, belonging to the field of a refrigeration device. The lock for an ultralow temperature refrigerator according to the present invention is manipulated easily and conveniently. It comprises a lock body with a handle and a lock head, wherein the lock body has, on one side, a shaft hole which along with a rotating shaft of a lock seat attached to the refrigerator door forms a rotating mechanism; the lock body has on the other side a lock opening having the surface of a hump and being engaged with a lock tab of the lock head to form a locking-in mechanism; and an empty cavity containing a lock core is provided above the shaft hole of the lock body with respect to the diagonal direction and accommodates therein a lock-body locking and limiting mechanism formed by a lock stop flake fixed on the lock seat and the empty cavity containing the lock core. The present invention is advantageous at the simple structure, facilitated locking and unlocking, and super effects in use and applicable to the door of a refrigerator, an ultralow temperature refrigerator, and a freezer.

### TECHNICAL FIELD

The present invention discloses a lock for an ultralow temperature refrigerator, belonging to the field of a refrigeration device.

### BACKGROUND ART

An ultralow refrigerator is widely employed in many fields such as medicine, a biology product, electronical materials to preserve erythrocytes, leucocytes, skins, marrows and bacillus and used in low temperature tests of electronical devices and special materials. As life sciences and biological gene engineering are developed increasingly, they are exploited to a greater extent in terms of application. Along with it, products are expected to have increasingly high performances such as performance stability, simply operations, convenient usage, long lifespan and the like simultaneously with reaching the operation temperature.

In the prior art, the locks for an ultralow temperature refrigerator are difficult to satisfy the demands such as simple operation and safe and convenient usage. In particular, the operations of unlocking and locking are conducted with difficulty. In some cases, even using both hands to manipulate the lock, it is difficult to open or close the refrigerator. The reason mainly is that the direction of the force for the opening or closing is not coordinated with the moving direction of the refrigerator door which can not fulfill the cooperation therebetween.

### SUMMARY OF THE INVENTION

Aiming to overcome the disadvantages occurred in the prior art, the present invention provides a lock for an ultralow temperature refrigerator which can be operated easily and conveniently.

The present invention is characterized in that:

1. By the rotating about a lock shaft, the lock opening with hump is engaged with the lock tab of the lock head so as to make the direction of the force for opening or closing is coordinated with the moving direction of the door, forming the cooperation therebetween;

2. A lock stop flake held on the lock seat and positioned in the cavity of the lock body is used in the positioning under two freedom statuses wherein one is the status after locking the lock body and the other is the status after the unlocking the lock body;

3. One branch is designed to have an inversed U handle with a S-shaped bending such that the refrigerator may be locked or unlocked using one hand or even one finger and an operator might be apart from the refrigerator door during the operation so as to be not injured.

4. A hanging-down nose integrated with the lock head is cooperated with a hanging-up nose on one side of the lock body to form an outside-hanging nose, obtaining the refrigerator having two locks and maximum safety of the locking-in.

In particular, the construction of the present invention is described in detail hereinafter.

The lock for an ultralow refrigerator comprises a lock body with a handle and a lock head, wherein the lock body is on its one side provided with a shaft hole which, along with a rotating shaft of a lock seat attached to the refrigerator door, forms a rotating mechanism; a lock opening which has hump surface and is located on the other side of the lock body is engaged with a lock tab of the lock head to form a locking-in mechanism; an empty cavity containing a lock core is provided above a shaft hole of the lock body with respect to the diagonal direction and accommodates therein a lock-body locking and positioning mechanism which is formed by a lock stop flake fixed on the lock seat and the empty cavity containing the lock core.

The lock stop flake is a rectangle rigid flake with a fixing screw hole wherein two adjacent sides have right-angle bending respectively to form a horizontal plane and a vertical plane.

The lock head comprises a lock-head seat, a fixing screw hole on the lock-head seat, a lock tab connected with the lock-head seat, and a hanging-down nose.

The outer edge of the lock body adjacent to the side of the hump has a hanging-up nose which can be overlapped with the hanging-down nose of the lock-head seat wherein the hanging-up and hanging-down noses form an outside-hanging nose during the locked-in engagement of the lock body with the lock-head seat.

The handle is, in form of inverted U, mounted on the lock body wherein one branch thereof closer to the door front face has S bending shape apart from the door.

When making use of the present invention, the lock seat along with the lock body is mounted on the side face of the door and the load head is mounted on corresponding side of the refrigerator body. The handle is pushed such that the door approaches the body until the engagement of the lock opening with the lock tab. During the opening, the handle is pulled such that the lock body rotates about the lock shaft and simultaneously the lock opening is separated from the lock tab.

The present invention is advantageous at the simple structure, stable performances, and super effects in use and applicable to the door of a refrigerator, an ultralow refrigerator and a freezer.

Hereinafter, the present invention will be further described in conjunction with the accompany figures.

### BRIEF DESCRIPTION OF THE DRAWINGS

FIG. 1 is a structural schematic view of a lock for a refrigerator;

FIG. 2 is a schematic view illustrating the limit position of the lock body during the unlocking of the lock;

FIG. 3 is a schematic view illustrating the limit position of the lock body during the unlocking of the lock;

FIG. 4 is a construction schematic view of the lock stop flake;

FIG. 5 is a structural schematic view of the handle; and

FIG. 6 is a structural schematic view of the lock head.

### DESCRIPTION OF PREFERRED EMBODIMENTS

In one embodiment, a refrigerator lock comprises a lock body 1 and a lock head 2 with the lock body 1 having a handle, wherein the lock body 1 has on one side a shaft hole 7 which, along with a rotating shaft of a lock seat fixed on the refrigerator door, forms a rotating mechanism, the lock body 1 has on the other side a lock opening 8 which has the surface of a hump 9 and is engaged with a lock tab 16 of the lock head 2 to form a locking-in mechanism, an empty cavity containing a lock core is provided above the shaft hole 7 of the lock body 1 with respect to the diagonal direction and accommodates therein a lock-body locking and limiting mechanism formed by a lock stop flake 6 fixed on the lock seat and the empty cavity containing the lock core.

The lock stop flake 6 is a rectangle metal flake with a fixing screw hole wherein two adjacent sides have right-angle bending respectively to form a horizontal plane 10 and a vertical plane 11.

The lock head 2 comprises a lock-head seat 13, a fixing screw hole 15 on the lock-head seat 13, a lock tab 16 connected with the lock-head seat, a hanging-down nose 14.

The lock tab 16 is a bolt shaft in cylindrical shape and has outside a movable sleeve contributive to the sliding of the lock opening.

The outer edge of the lock body 1 adjacent to the side of a hump 9 has a hanging-up nose 3 which can be overlapped with the hanging-down nose 14 of the lock-head seat 13 wherein the hanging-up nose together with the hanging-down nose 14 forms an outside-hanging nose. Each of the hanging-up nose and the hanging-down nose has a lock hole.

The handle 5 is, in form of inverted U, mounted on the lock body 1 wherein one branch thereof closer to the door front face has S bending shape 12 apart from the door.

The positions of the lock body and the lock stop flake in the respective operational status are as follows:

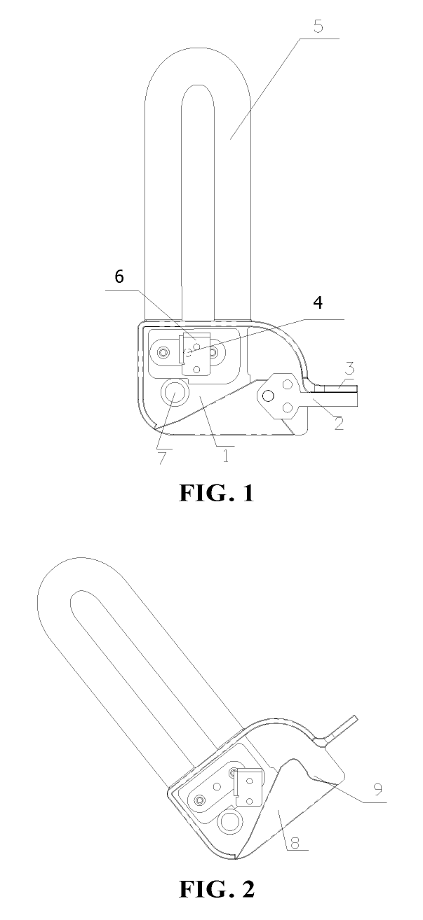

Locking-in status (referring to FIG. 1)

The horizontal plane of the lock stop flake is parallel with the upper edge of the empty cavity containing the lock core and the lock bolt of the lock core is rotated out therefrom to stand on the internal side of the vertical plane so as to prevent the lock body from rotating.

The first opening status (referring to FIG. 2)

The handle is rotated, resulting in the edge of the horizontal plane of the lock stop flake making contact with one side of the empty cavity containing the lock core wherein the lock body is in the freedom status of large rotating angle.

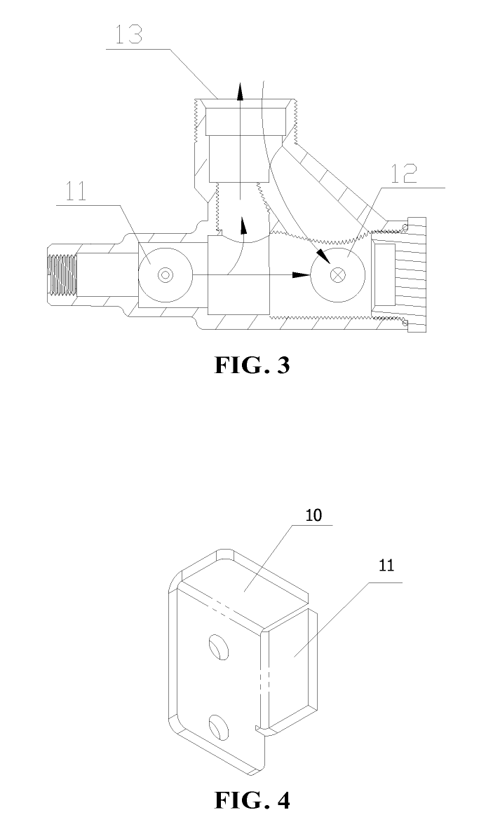

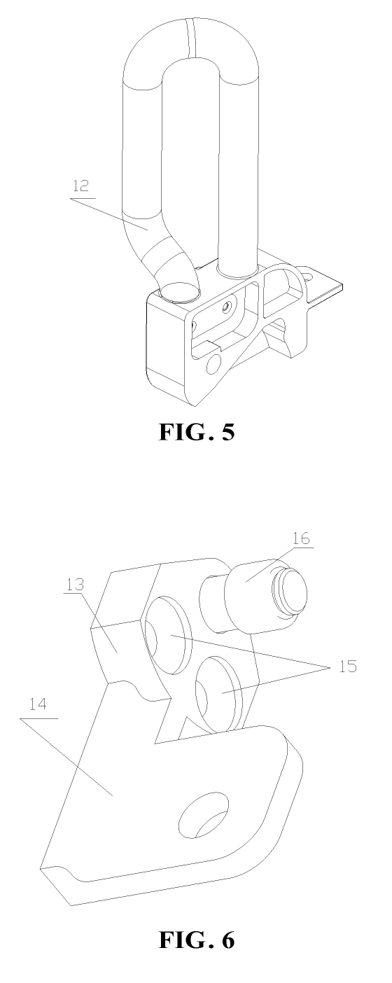

3. The second opening status (referring to FIG. 3)

The handle is rotate backwards, resulting in the edge of the horizontal plane of the lock stop flake making contact with the upper edge of the empty cavity containing the lock core wherein the lock body is in the freedom status of small rotating angle.

What is claimed is:

1. A lock for an ultralow refrigerator comprising:
a lock body with a handle and a lock head, the lock body on its one side provided with a shaft hole which, along with a rotating shaft of a lock seat attached to the refrigerator door, forms a rotating mechanism;
a lock opening which has the surface of a hump and is located on the other side of the lock body is engaged with a lock tab of the lock head to form a locking-in mechanism; and
an empty cavity containing a lock core is provided above the shaft hole of the lock body with respect to the diagonal direction and accommodates therein a lock-body locking and limiting mechanism which is formed by a lock stop flake fixed on the lock seat and the empty cavity containing the lock core.

2. The lock for an ultralow refrigerator according to claim 1, wherein the lock stop flake is a rectangle metal flake with a fixing screw hole wherein two adjacent sides have right-angle bending respectively to form a horizontal plane and a vertical plane.

3. The lock for an ultralow refrigerator according to claim 1, wherein the lock head includes a lock-head seat, a fixing screw hole on the lock-head seat, a lock tab connected with the lock-head seat, a hanging-down nose.

4. The lock for an ultralow refrigerator according to claim 1, wherein the lock tab is a bolt shaft in cylindrical shape and has outside a movable sleeve contributive to the sliding of the lock opening.

5. The lock for an ultralow refrigerator according to claim 1, wherein the outer edge of the lock body adjacent to the side of a hump has a hanging-up nose which can be overlapped with a hanging-down nose of the lock-head seat wherein the hanging-up nose together with the hanging-down nose forms an outside-hanging nose and each of the hanging-up nose and the hanging-down nose has a lock hole.

6. The lock for an ultralow refrigerator according to claim 1, wherein the handle is, in form of inverted U, mounted on the lock body wherein one branch thereof closer to the door front face has S bending shape apart from the door.
